(19) United States
(12) Patent Application Publication
(10) Pub. No.: US 2012/0056101 A1
(43) Pub. Date: Mar. 8, 2012

(54) ION DOPING APPARATUS AND ION DOPING METHOD

(75) Inventors: Erumu KIKUCHI, Atsugi (JP); Wataru SEKINE, Atsugi (JP)

(73) Assignee: SEMICONDUCTOR ENERGY LABORATORY CO., LTD., Atsugi-shi (JP)

(21) Appl. No.: 13/219,189

(22) Filed: Aug. 26, 2011

(30) Foreign Application Priority Data
Sep. 3, 2010 (JP) 2010-197464

(51) Int. Cl. H01J 27/16

(52) U.S. Cl. 250/424; 250/423 R

(57) ABSTRACT

When hydrogen is introduced into a plasma chamber which includes the dielectric plate as part of an exterior wall, and surface waves are generated on the dielectric plate using microwaves, a region where negative hydrogen ions are easily generated is formed in the plasma chamber. Since only hydrogen negative ions each with a molecular weight of 1 are generated, only ions with the same mass can be added to an object by application of an electric field, without mass separation.

### BACKGROUND OF THE INVENTION

1. Field of the Invention

The present invention relates to an ion doping apparatus and an ion doping method using the ion doping apparatus. One embodiment of the disclosed invention relates to an ion doping apparatus in which negative hydrogen ions are added and an ion doping method by which negative hydrogen ions are added.

2. Description of the Related Art

A technique by which impurity elements for controlling valence electrons of a semiconductor are ionized, accelerated by an electric field, and added is known as an ion implantation method.

An ion doping apparatus (also referred to as a doping apparatus) has a doping chamber connected to an ion source. In the ion doping apparatus, a substrate is placed in the doping chamber in a vacuum state, and ions generated in the ion source are accelerated by an electric field and added to an outermost layer of the substrate. In this specification, a substrate is one of objects to be doped. The ion source includes a plasma chamber, an accelerating electrode system (an extracting electrode and an accelerating electrode) which extracts ions generated in the plasma chamber, and a decelerating electrode system (a suppressor electrode and a ground electrode) which controls the inflow of secondary electrons. As the electrodes, porous electrodes are generally used and ions pass through pores thereof and reach the doping chamber. Such flow of ions is referred to as ion flow.

As a method for generating plasma in the ion source, a DC discharge method, a high frequency discharge method, a microwave discharge method, and the like are given. Further, plasma can be trapped in the ion source by applying a magnetic field; thus, a cusp magnetic field is generated by disposing a permanent magnet on the periphery of the plasma chamber in some cases.

In a doping apparatus, mass separation is not performed in many cases; therefore, all positive ions of ion species generated in a plasma chamber are accelerated by an electric field generated with an extracting electrode and are added to a semiconductor layer or the like. Ions are obtained by making hydrogen, or diborane (B₂H₆), phosphine (PH₃), or the like diluted with hydrogen or the like be plasma. These ions are generally accelerated by applying a voltage of approximately 1 kV to 100 kV. For example, when a substrate is doped with hydrogen without mass separation, ions such as H⁺ ions, H₂⁺ ions, and H₃⁺ ions are generated, so that a substrate containing hydrogen in a relatively wide range in the depth direction can be obtained.

There is an ion implantation apparatus, which is similar to a doping apparatus. With this apparatus, ion flow is separated into ion flows of different molecular weights of ions, that is, different masses of ions, and the apparatus is used when the distribution of ions in the depth direction is desirably narrow. Ion flow is separated by applying a magnetic field to ions to cause Lorentz force. Accordingly, ions with uniform molecular weight can be added to an object; thus, the depth distribution of ions can be made to be narrow.

As one of techniques utilizing an ion implantation apparatus, manufacture of an SOI (silicon on insulator) substrate can be given. In an SOI substrate, a single crystal silicon thin film is formed on an insulating surface. With the use of such an SOI substrate, transistors in an integrated circuit can be formed such that they are completely insulated electrically, and completely-depleted transistors can be formed. Thus, a semiconductor integrated circuit with high added value such as high integration, high-speed driving, and low power consumption can be realized.

To manufacture an SOI substrate, for example, a SIMOX technique and a bonding technique are utilized. In a bonding technique, for example, a hydrogen ion implantation process is used. Specifically, first, hydrogen ions are implanted into a silicon wafer, whereby a hydrogen embrittled layer is formed at a predetermined depth from a surface of the silicon wafer. Next, a silicon oxide film is formed by oxidizing another silicon wafer which serves as a base substrate. After that, the surface into which the hydrogen ions are implanted is bonded to the silicon oxide film, so that the two silicon wafers are integrated. Then, by performing heat treatment, the silicon wafer are separated along the hydrogen embrittled layer. Thus, an SOI substrate is completed. In an SOI substrate, a single crystal silicon thin film is required to be planarized to a high degree; therefore, it is preferable to use an ion implantation apparatus with which the distribution of depth at which ions are added can be narrower.

However, an ion implantation apparatus has a mass separation function, and thus has low throughput and further is very expensive. For production of an inexpensive SOI substrate, it is necessary to use an apparatus with which hydrogen can be added at a predetermined depth such that the depth distribution is narrow, without mass separation. As an example of such an apparatus, the one is devised in which negative hydrogen ions are generated, accelerated by an electric field, and added to an object. Negative hydrogen ions have no necessity of mass separation because only hydrogen ions each with a molecular weight of 1 are generated, unlike positive hydrogen ions. In order to generate numerous negative hydrogen ions, for example, a magnetic field for capturing electrons with high energy which are generated in hydrogen plasma is preferably created. Since electrons with high energy each have a function of damaging negative hydrogen ions, when such a magnetic field is created, generation of negative hydrogen ions can be facilitated. Further, for example, a method is given in which vapor of alkali metal such as cesium, rubidium, or potassium is introduced into an ion source and attached to a negatively-biased metal surface (referred to as a target), so that electrons are transported from the target to hydrogen atoms and negative hydrogen ions are generated (see Patent Documents 1 and 2).

### REFERENCE

[Patent Document 1] Japanese Published Patent Application No. 2000-12285
[Patent Document 2] Japanese Published Patent Application No. 2000-21597

### SUMMARY OF THE INVENTION

As shown in the conventional techniques, by creating a magnetic field or providing a target in an ion doping apparatus, negative hydrogen ions can be generated efficiently; however, in both of the techniques, complicated equipment and a rare element are necessary, which is disadvantageous from the viewpoint of the purpose of producing an inexpensive SOI substrate. Further, a target to which alkali metal is to be attached is provided by utilizing an interior wall of a plasma chamber or by disposing a metal member inside the plasma chamber, for example. With such a target, it is difficult to evenly distribute negative hydrogen ions in a wide area, and such a target is unsuitable for processing, in particular, a large substrate such as a silicon wafer with a diameter of 300 mm or a silicon wafer with a diameter of 450 mm which may be the mainstream in the future, with high throughput.

In view of the above, an object of one embodiment of the disclosed invention is to provide an ion doping apparatus with a simple structure without a mass separation function, in which only hydrogen ions with the same mass can be added. Another object of one embodiment of the disclosed invention is to provide an ion doping apparatus in which only hydrogen ions with the same mass can be added to a wafer with a diameter of 300 mm or more at a time. Another object of one embodiment of the disclosed invention is to provide a method for performing the doping.

An ion doping apparatus according to one embodiment of the disclosed invention includes a waveguide path for propagation of microwaves, a dielectric plate which converts the microwaves into surface waves, a plasma chamber which includes the dielectric plate as part of an exterior wall, a hydrogen supply portion which supplies hydrogen to the plasma chamber, and an electric field generating portion which accelerates negative ions generated from the hydrogen by the surface waves in the plasma chamber. The dielectric plate is a partition between the waveguide path and the plasma chamber.

The electric field generating portion includes an extracting electrode which extracts negative ions and an accelerating electrode which accelerates the negative ions. Instead of the accelerating electrode, a potential supplying portion which supplies a potential higher than that of the extracting electrode to an object to be doped may be provided.

The allowable temperature limit of the dielectric plate is preferably higher than or equal to 1300 K. With such a condition, the ion doping apparatus can sufficiently resist heat of plasma. Further, the dielectric plate needs to have strength enough to resist atmospheric pressure because it is a partition between a vacuum and the air. Examples of such a material are quartz glass and alumina. When a structure where the inside of the waveguide path for propagation of microwaves can be kept in a vacuum is employed, the dielectric plate does not necessarily have strength enough to resist atmospheric pressure. Since it is relatively easy to use quartz glass or alumina with a large area, by using quartz glass or alumina to form a dielectric plate which can cover a circle with a diameter of 300 mm or 450 mm, a silicon wafer with a diameter of 300 mm or 450 mm can be processed in one step, which is preferable. That is to say, the size of the dielectric plate is preferably large enough to cover a circle with a diameter of 300 mm or 450 mm. The shape of the dielectric plate can be circular or rectangular.

It is preferable that the distance between the dielectric plate and the extracting electrode be greater than or equal to 20 mm because a region where the mean value of electron energy (electron temperature) is approximately 1 eV can be formed in the plasma chamber and thus negative hydrogen ions are likely to be generated. Although it is preferable to set the distance to less than or equal to 200 mm in terms of a reduction in size of an apparatus, the distance may be up to approximately 400 mm. In the range of at least 20 mm to 200 mm in the distance, the mean value of electron energy is approximately 1 eV. Therefore, negative hydrogen ions are likely to be generated in the whole region of the range. Note that when the mean value of electron energy is approximately 1 eV, electron energy ranges between 0 eV to 3 eV. This range of electron energy includes 1 eV to 3 eV with which negative hydrogen ions are likely to be generated. It is preferable that the mean value of electron energy be not higher than 1.5 eV because an electron with an energy of higher than 3 eV has a function of damaging negative hydrogen ions. When the mean value of electron energy is lower than 0.5 eV, the number of electrons with energies of 1 eV to 3 eV is significantly small, which is not preferable. Therefore, the mean value of electron energy in the plasma chamber is preferably higher than or equal to 0.5 eV and lower than or equal to 1.5 eV.

One embodiment of the disclosed invention is an ion doping method in which microwaves are supplied to a dielectric plate through a waveguide path to generate surface waves on the dielectric plate, and hydrogen in contact with the surface waves is made to be plasma, the negative hydrogen ions which have been made to be plasma are accelerated by application of an electric field, and the negative ions are added to an object.

Thus, with a very simple apparatus structure, negative hydrogen ions can be generated without the use of rare metal, or application of a magnetic field for capturing electrons with high energy. Since only negative hydrogen ions each with a molecular weight of 1 are generated, negative hydrogen ions with uniform molecular weight can be accelerated by an electric field without mass separation. Therefore, addition of hydrogen in a significantly narrow distribution in the depth direction is possible; thus, for example, the thickness of a hydrogen embrittled layer formed in a manufacturing process of an SOI substrate can be very small. Accordingly, a single crystal silicon film with significantly high planarity can be obtained. Since negative hydrogen ions are generated evenly at a predetermined distance from the dielectric plate, the area of plasma can be set freely depending on the area of the dielectric plate. The area can be, for example, 1 meter or more square; thus, a wafer with a diameter of 300 mm or more can be processed in one step. Further, it is easy to process a plurality of wafers at the same time.

### BRIEF DESCRIPTION OF THE DRAWINGS

In the accompanying drawings:

FIG. 1 illustrates a doping apparatus according to one embodiment of the present invention;

FIG. 2 illustrates a doping apparatus according to one embodiment of the present invention; and

FIGS. 3A and 3B illustrate a radial line slot antenna.

### DETAILED DESCRIPTION OF THE INVENTION

Hereinafter, embodiments will be described in detail with reference to the drawings. Note that the present invention is not limited to the description of the embodiments, and it is apparent to those skilled in the art that modes and details can be modified in various ways without departing from the spirit of the present invention disclosed in this specification and the like. Structures of the different embodiments can be implemented in appropriate combination. Note that in the structures of the present invention described below, like reference numerals refer to like portions or portions having similar functions, and the description thereof is omitted. On the description of the invention with reference to the drawings, a reference numeral indicating the same part is used in common throughout different drawings, and the repeated description is omitted. Note that a doping apparatus in this specification refers to a general apparatus in which ions of an element are accelerated and the element is added to an object.

### Embodiment 1

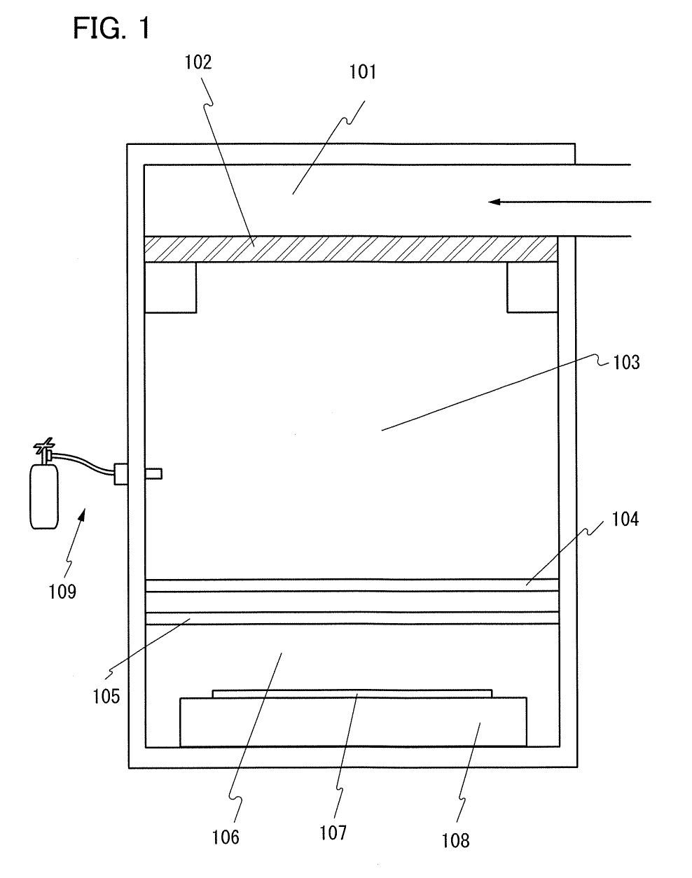

In this embodiment, a doping apparatus according to one embodiment of the present invention will be described with reference to FIG. 1.

A doping apparatus according to one embodiment of the present invention includes a waveguide path 101 for propagation of microwaves, a dielectric plate 102 which converts the microwaves into surface waves, a plasma chamber 103 which includes the dielectric plate 102 as part of an exterior wall, a hydrogen supply portion 109 which supplies hydrogen to the plasma chamber 103, an extracting electrode 104 which extracts negative ions generated in the plasma chamber 103, an accelerating electrode 105 which accelerates the negative ions, a doping chamber 106 which holds an object to which the accelerated negative ions are added, and a stage 108 on which a substrate 107 that is an object to be doped is placed. The dielectric plate 102 is a partition between the waveguide path 101 and the plasma chamber 103. The extracting electrode 104 and the accelerating electrode 105 are electric field generating portions according to one embodiment of the present invention, and a potential supplied to the accelerating electrode 105 is set higher than that of the extracting electrode 104. Instead of the accelerating electrode 105, a potential supplying portion which supplies a potential higher than that of the extracting electrode 104 to the object to be doped may be provided. The extracting electrode 104 is part of the exterior wall of the plasma chamber 103.

Although positive ions can be added to the object to be doped without an electrode such as the extracting electrode 104, the extracting electrode 104 is necessary for holding plasma in adding negative ions. The reason is as follows. Since a space-charge layer called a sheath is formed in a region from a surface in contact with plasma to the vicinity of the surface, the potential of plasma in the direction of an electric field of the space-charge layer is higher than the potential of the surface in contact with plasma. Accordingly, negative ions cannot approach such a surface. Therefore, in the case where part of the surface is an object to be doped, positive ions can be added to the object, whereas negative ions cannot be added thereto.

The waveguide path 101 is for propagation of microwaves. In the waveguide path 101, for example, microwaves of 2.45 GHz and 1 kW are propagated. The conditions of microwaves suitable for one embodiment of the present invention are not limited thereto. The applicable range of the frequency of microwaves in one embodiment of the present invention is higher than or equal to 0.1 GHz and lower than or equal to 10 GHz. Specifically, microwaves of 8.30 GHz and 1.6 kW may be used as another example. Accordingly, surface waves are generated on the dielectric plate 102. At this time, in the case where the plasma chamber 103 is filled with, for example, hydrogen with a pressure of approximately 2 Pa to 200 Pa from the hydrogen supply portion 109, electrons of hydrogen are accelerated to become plasma by an electric field of the surface waves. In a region within approximately 20 mm to 30 mm from the vicinity of the dielectric plate 102, the energy of electrons is high and thus, negative hydrogen ions are not likely to be generated. However, in a region which is more distant from the dielectric plate 102 than the region, the mean value of the energy of electrons (electron temperatures) is approximately 1 eV, which is within the energy range suitable for generation of negative hydrogen ions; therefore, the distance between the dielectric plate 102 and the extracting electrode 104 is preferably greater than or equal to 20 mm, or greater than or equal to 30 mm. Surface waves of the dielectric plate 102 are evenly propagated on the entire dielectric plate, so that negative hydrogen ions are also evenly distributed under the plate. Thus, negative hydrogen ions can be evenly distributed in the range equal to the area of the dielectric plate 102. Since quartz, glass, alumina, or the like can be used for the dielectric plate 102, the dielectric plate 102 which is 1 meter or more square can be easily obtained. Therefore, for example, a wafer with a diameter of 300 mm can be processed in one step. Necessary properties of the dielectric plate 102 are low dielectric loss, a heat resistance of 1300 K or more, the strength enough to withstand a vacuum window, plasma resistance, and the like; thus, a plate with those properties can be used as the dielectric plate 102.

The extracting electrode 104 is used for extracting generated hydrogen negative ions in a specific direction. Negative hydrogen ions extracted by the extracting electrode 104 are accelerated to have a desired velocity by the accelerating electrode 105 and reach the substrate 107. At that time, there are only negative hydrogen ions each with a molecular weight of 1; thus, the distribution of depth at which hydrogen is added to the substrate 107 can be extremely narrow. Not used here, a decelerating electrode system (a suppressor electrode and a ground electrode) which controls the flow of secondary electrons may be further provided. The substrate 107 is introduced into the doping chamber 106 from a transfer portion which is not illustrated, and is placed on the stage 108. The stage 108 may be provided with a scan portion as necessary. With the stage 108, a similar process can be performed on the substrate 107 larger than the dielectric plate 102, as well.

Although not illustrated here, an evacuating device is necessary for evacuating the plasma chamber 103. As the evacuating device, a dry pump, a mechanical booster pump, a turbo molecular pump, or the like, or a combination thereof may be used.

According to one embodiment of the present invention, a doping apparatus can be provided which does not have a mass separation function, can perform doping a wafer having an area with a diameter of 300 mm or more in one step, and has a significantly narrow distribution of hydrogen in the depth direction. Further, since a doping apparatus according to one embodiment of the present invention does not include an electrode in a discharge region, maintenance such as replacement of a cathode filament is unnecessary. Thus, the doping apparatus is superior to a doping apparatus using DC are discharge also in such a viewpoint.

This embodiment can be implemented in combination with the other embodiment, as appropriate.

### Embodiment 2

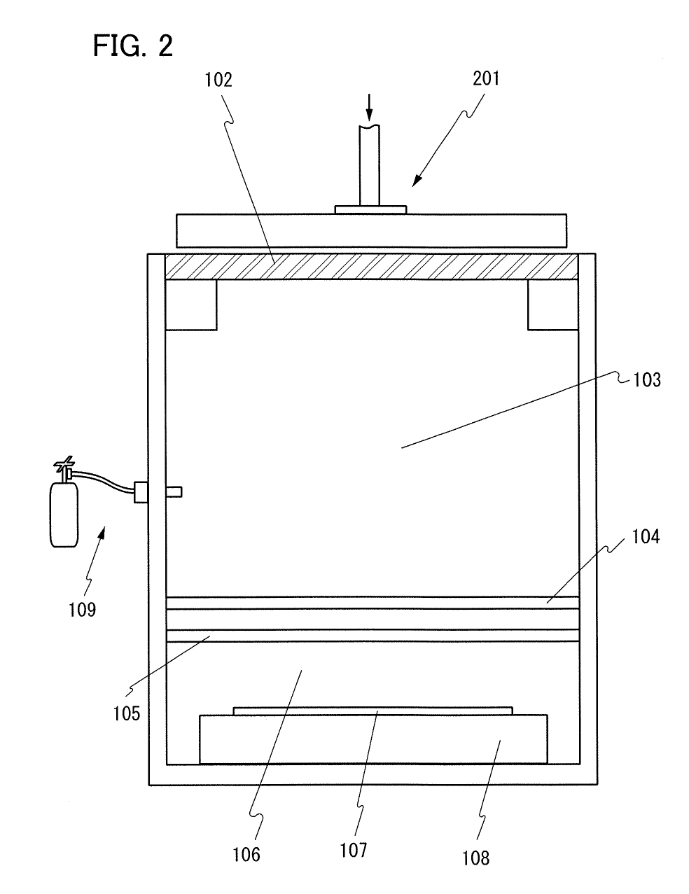

In this embodiment, a doping apparatus according to one embodiment of the present invention will be described with reference to FIG. 2.

A doping apparatus according to one embodiment of the present invention includes a radial line slot antenna 201 for propagation of microwaves, the dielectric plate 102 which converts the microwaves into surface waves, the plasma chamber 103 which includes the dielectric plate 102 as part of an exterior wall, the hydrogen supply portion 109 which supplies hydrogen to the plasma chamber 103, the extracting electrode 104 which extracts negative ions generated in the plasma chamber 103, the accelerating electrode 105 which accelerates the negative ions, the doping chamber 106 which holds an object to which the accelerated negative ions are added, and the stage 108 on which the substrate 107 that is an object to be doped is placed. The dielectric plate 102 is a partition between the waveguide path 101 and the plasma chamber 103. The extracting electrode 104 and the accelerating electrode 105 are electric field generating portions according to one embodiment of the present invention, and a potential supplied to the accelerating electrode 105 is higher than that supplied to the extracting electrode 104. Instead of the accelerating electrode 105, a potential supplying portion which supplies a potential higher than that of the extracting electrode 104 to the object to be doped may be provided. The extracting electrode 104 is part of the exterior wall of the plasma chamber 103.

Although positive ions can be added to the object to be doped without an electrode such as the extracting electrode 104, the extracting electrode 104 is necessary for holding plasma in adding negative ions. The reason is as follows. Since a space-charge layer called a sheath is formed in a region from a surface in contact with plasma to the vicinity of the surface, the potential of plasma in the direction of an electric field of the space-charge layer is higher than the potential of the surface in contact with plasma. Accordingly, negative ions cannot approach such a surface. Therefore, in the case where part of the surface is an object to be doped, positive ions can be added to the object, whereas negative ions cannot be added thereto.

The radial line slot antenna 201 is for propagation of microwaves. In the radial line slot antenna 201, for example, microwaves of 2.45 GHz and 1 kW are incident from the direction shown by the arrow in FIG. 2 and are propagated to a plate portion. The plate portion includes the dielectric plate 102. The conditions of microwaves suitable for one embodiment of the present invention are not limited thereto. The applicable range of the frequency of microwaves in one embodiment of the present invention is higher than or equal to 0.1 GHz and lower than or equal to 10 GHz. Specifically, microwaves of 8.30 GHz and 1.6 kW may be used as another example. Accordingly, surface waves are generated on the dielectric plate 102. In this case, in the case where the plasma chamber 103 is filled with, for example, hydrogen with a pressure of approximately 2 Pa to 200 Pa from the hydrogen supply portion 109, electrons of hydrogen are accelerated to become plasma by an electric field of the surface waves. In a region within approximately 20 mm to 30 mm from the vicinity of the dielectric plate 102, the energy of electrons is high and thus, negative hydrogen ions are not likely to be generated. However, in a region which is more distant from the dielectric plate 102 than the region, the mean value of the energy of electrons (electron temperatures) is approximately 1 eV, which is within the energy range suitable for generation of negative hydrogen ions; therefore, the thickness of the inside of the plasma chamber is preferably greater than or equal to 20 mm, or greater than or equal to 30 mm. Surface waves of the dielectric plate 102 are evenly propagated entirely on a portion of the dielectric plate, which forms an interior wall of the plasma chamber, so that negative hydrogen ions are also evenly distributed under the plate. Thus, negative hydrogen ions can be evenly distributed in the range equal to the area of the dielectric plate 102. Since quartz glass, alumina, or the like can be used for the dielectric plate 102, the dielectric plate 102 which is 1 meter or more square can be easily obtained. Therefore, for example, wafers each with a diameter of 300 mm can be processed at the same time. Necessary properties of the dielectric plate 102 are low dielectric loss, a heat resistance of 1300 K or more, the strength enough to withstand a vacuum window, plasma resistance, and the like; thus, a plate with those properties can be used as the dielectric plate 102.

The extracting electrode 104 is used for extracting generated hydrogen negative ions in a specific direction. Negative hydrogen ions extracted by the extracting electrode 104 are accelerated to have a desired velocity by the accelerating electrode 105 and reach the substrate 107. At that time, there are only negative hydrogen ions each with a molecular weight of 1; thus, the distribution of depth at which hydrogen is added to the substrate 107 can be extremely narrow. Not used here, a decelerating electrode system (a suppressor electrode and a ground electrode) which controls the flow of secondary electrons may be further provided. The substrate 107 is introduced into the doping chamber 106 from a transfer portion which is not illustrated, and is placed on the stage 108. The stage 108 may be provided with a scan portion as necessary. With such a structure, a similar process can be performed on the substrate 107 larger than the dielectric plate 102, as well.

Although not illustrated here, an evacuating device is necessary for evacuating the plasma chamber 103. As the evacuating device, a dry pump, a mechanical booster pump, a turbo molecular pump, or the like, or a combination thereof may be used.

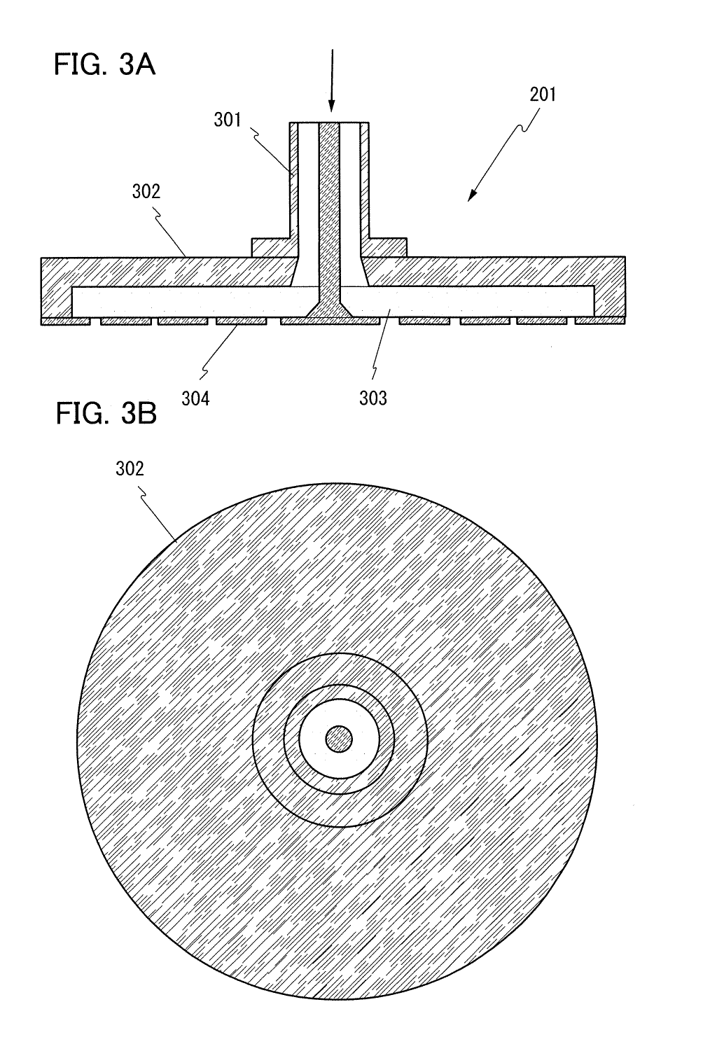

Next, the radial line slot antenna 201 will be described with reference to FIGS. 3A and 3B. FIG. 3A is a cross-sectional view thereof and FIG. 3B is a plan view thereof.

In FIG. 3A, the radial line slot antenna 201 includes a waveguide 301, a metal plate 302, a dielectric plate 303, and a metal plate 304 having a plurality of slots (narrow grooves). Microwaves supplied through the waveguide 301 in a central portion are propagated through a waveguide path formed by the dielectric plate 303 between the metal plate 302 and the metal plate 304 and travel downward through the slots. The distribution of the microwaves depends on the shapes, the arrangement, or the like of the slots. The radial line slot antenna 201 is preferably designed to have a circular shape as in FIG. 3B because of its structure, which is suitable for a process of a circular silicon wafer or the like. It is needless to say that with this device, an object having a quadrangular shape or any other shape may be processed.

According to one embodiment of the present invention, a doping apparatus can be provided which does not have a mass separation function, can perform doping on a wafer having an area with a diameter of 300 mm or more in one step, and has a significantly narrow distribution of hydrogen in the depth direction. Further, since a doping apparatus according to one embodiment of the present invention does not include an electrode in a discharge region, maintenance such as replacement of a cathode filament is unnecessary. Thus, the doping apparatus is superior to a doping apparatus using DC are discharge also in such a viewpoint.

This embodiment can be implemented in combination with the other embodiment, as appropriate.

This application is based on Japanese Patent Application serial no. 2010-197464 filed with the Japan Patent Office on Sep. 3, 2010, the entire contents of which are hereby incorporated by reference.

What is claimed is:

1. An ion doping apparatus comprising:
a waveguide path through which microwaves are propagated;
a plasma chamber including a dielectric plate, the dielectric plate configured to convert the microwaves into surface waves;
a hydrogen supply portion which supplies hydrogen to the plasma chamber; and
an electric field generating portion configured to accelerate negative ions generated from the hydrogen by the surface waves in the plasma chamber,
wherein the dielectric plate is a partition between the waveguide path and the plasma chamber.

2. The ion doping apparatus according to claim 1, wherein an upper temperature limit of the dielectric plate is higher than or equal to 1300 K.

3. The ion doping apparatus according to claim 1, wherein the dielectric plate comprises quartz glass or alumina.

4. The ion doping apparatus according to claim 1, wherein the dielectric plate has a size large enough to cover a circle with a diameter of 300 mm or more.

5. The ion doping apparatus according to claim 1, wherein the dielectric plate has a size large enough to cover a circle with a diameter of 450 mm or more.

6. The ion doping apparatus according to claim 1, wherein the electric field generating portion includes an extracting electrode.

7. The ion doping apparatus according to claim 6, wherein the extracting electrode functions as part of an exterior wall of the plasma chamber.

8. The ion doping apparatus according to claim 6, wherein a distance between the dielectric plate and the extracting electrode is greater than or equal to 20 mm and less than or equal to 200 mm.

9. The ion doping apparatus according to claim 1, wherein the electric field generating portion includes an accelerating electrode.

10. The ion doping apparatus according to claim 1, wherein the electric field generating portion includes a potential supplying portion which supplies a potential to an object to be doped.

11. An ion doping apparatus comprising:
a waveguide path through which microwaves are propagated;
a plasma chamber including a dielectric plate, the dielectric plate configured to convert the microwaves into surface waves;
a hydrogen supply portion which supplies hydrogen to the plasma chamber;
an electric field generating portion configured to accelerate negative ions generated from the hydrogen by the surface waves in the plasma chamber; and
a doping chamber having a stage for holding an object to be doped,
wherein the dielectric plate is a partition between the waveguide path and the plasma chamber.

12. The ion doping apparatus according to claim 11, wherein an upper temperature limit of the dielectric plate is higher than or equal to 1300 K.

13. The ion doping apparatus according to claim 11, wherein the dielectric plate comprises quartz glass or alumina.

14. The ion doping apparatus according to claim 11, wherein the dielectric plate has a size large enough to cover a circle with a diameter of 300 mm or more.

15. The ion doping apparatus according to claim 11, wherein the dielectric plate has a size large enough to cover a circle with a diameter of 450 mm or more.

16. The ion doping apparatus according to claim 11, wherein the electric field generating portion includes an extracting electrode.

17. The ion doping apparatus according to claim 16, wherein the extracting electrode functions as part of an exterior wall of the plasma chamber.

18. The ion doping apparatus according to claim 16, wherein a distance between the dielectric plate and the extracting electrode is greater than or equal to 20 mm and less than or equal to 200 mm.

19. The ion doping apparatus according to claim 11, wherein the electric field generating portion includes an accelerating electrode.

20. The ion doping apparatus according to claim 11, wherein the electric field generating portion includes a potential supplying portion which supplies a potential to the object to be doped.

21. An ion doping method comprising:
supplying microwaves to a dielectric plate through a waveguide path to generate surface waves on the dielectric plate;
activating hydrogen by an electric field of the surface waves to produce negative hydrogen ions; and
accelerating the negative hydrogen ions by an electronic field produced by an accelerating electrode toward an object.

22. The ion doping method according to claim 21, wherein the negative hydrogen ions are distributed in a range covering an area of the dielectric plate.

23. The ion doping method according to claim 21, wherein an upper temperature limit of the dielectric plate is higher than or equal to 1300 K.

24. The ion doping method according to claim 21, wherein the dielectric plate has a size large enough to cover a circle with a diameter of 300 mm or more.

25. The ion doping method according to claim 21, wherein the dielectric plate has a size large enough to cover a circle with a diameter of 450 mm or more.

26. An ion doping method comprising:
supplying microwaves to a dielectric plate through a waveguide path;
generating surface waves in a plasma chamber by converting the microwaves into the surface waves using the dielectric plate;
supplying hydrogen to the plasma chamber and generating negative hydrogen ions in the plasma chamber;
extracting the negative hydrogen ions from the plasma chamber by an extracting electrode; and
accelerating the negative hydrogen ions toward an object by an accelerating electrode.

27. The ion doping method according to claim 26, wherein the negative hydrogen ions are distributed in a range covering an area of the dielectric plate.

28. The ion doping method according to claim 26, wherein an upper temperature limit of the dielectric plate is higher than or equal to 1300 K.

29. The ion doping method according to claim 26, wherein the dielectric plate has a size large enough to cover a circle with a diameter of 300 mm or more.

30. The ion doping method according to claim 26, wherein the dielectric plate has a size large enough to cover a circle with a diameter of 450 mm or more.

31. The ion doping method according to claim 26, wherein a distance between the dielectric plate and the extracting electrode is greater than or equal to 20 mm and less than or equal to 200 mm.
